(19) United States
(12) Patent Application Publication
(10) Pub. No.: US 2014/0145460 A1
(43) Pub. Date: May 29, 2014

(54) RAIL WHEEL AND METHOD FOR PRODUCING A RAIL WHEEL

(71) Applicants: Matthias Niessner, Ismaning (DE); Christoph Siegl, Neuried (DE)

(72) Inventors: Matthias Niessner, Ismaning (DE); Christoph Siegl, Neuried (DE)

(73) Assignee: KNORR-BREMSE SYSTEME FÜR SCHIENENFAHRZEUGE GMBH, Munich (DE)

(21) Appl. No.: 14/116,213

(22) PCT Filed: May 7, 2012
(86) PCT No.: PCT/EP2012/058324

§ 371 Date: Dec. 23, 2013

(30) Foreign Application Priority Data
May 9, 2011 (DE) 10 2011 100 974.8

(51) Int. Cl. B60B 17/00

(52) U.S. Cl. CPC B60B 17/00
USPC 295/30; 295/1; 29/894.011

(57) ABSTRACT

A rail wheel with a wheel body and friction discs connected thereto on both sides by fastening elements, wherein a multi-layer coating is arranged at least between the respective contact surfaces of the friction discs and the contact surfaces of the wheel body with a coating which can be subjected to mechanically and thermally high loading. Also disclosed is a method for producing a rail wheel.

### PRIORITY CLAIM

This patent application is a U.S. National Phase of International Patent Application No. PCT/EP2012/058324, filed 7 May 2012, which claims priority to German Patent Application No. 10 2011 100 974.8, filed 9May 2011, the disclosures of which are incorporated herein by reference in their entirety.

### FIELD

Disclosed embodiments relate to a rail wheel and to a method for producing a rail wheel.

### SUMMARY

A connection of friction disks for decelerating a rail vehicle with a rail wheel is made possible by screwing the friction disks on a wheel web. This connection must be configured in such a way that the friction disks can expand upon heating and contract again upon cooling. This temperature-related expansion and contraction causes sliding movements of the friction disks on the wheel web. On account of the prestressing force of the screws, these sliding movements take place under a relatively high pressure.

Friction disks are typically delivered in a bare metallic form without a permanent coating. The disks may in this case be covered with an oil, which provides the friction disks with corrosion protection over a temporally limited space. Especially in the case of relatively long storage, in particular outdoor storage, the contact surfaces of the friction disk inter alia can corrode.

Some manufacturers have, for example, provided for the priming of the wheel web or else the application of an assembly lubricating paste, which, however, on account of the sliding movements, was gradually discharged again from the contact region between the wheel web and the friction disks, and which therefore cannot ensure that the friction between the wheel web and the friction disks is reduced over a relatively long time.

If the friction increases, however, frictional corrosion and adhesive wear, also known as fretting, can increasingly occur. This adhesive wear impedes the expansion and contraction of the brake disk upon braking and reduces the screw prestress. This in turn leads to higher loading and shortens the service life of the screw connection.

When implementing a well-defined, permanent contact between the brake disk and the wheel web, the use of a lubricating varnish known per se gives rise to the problem that a connection between a lubricating varnish layer and the metallic surface of a rail wheel or the contact surface of the wheel web did not have a sufficient durability. The lubricating varnish became detached from the metallic surface after a small number of brake operations. Metal on metal friction and the associated problems of adhesive wear and of frictional corrosion occurred.

Disclosed embodiments reduce the effect of the occurrence of adhesive wear in the case of a rail wheel having friction disks over a longer period of time.

### BRIEF DESCRIPTION OF THE FIGURES

Disclosed embodiments will be described in more detail hereinbelow with reference to the accompanying drawings, in which:

FIG. 1 shows a partial section of a rail wheel;

FIG. 2 shows a partial section of the rail wheel shown in FIG. 1 during assembly; and

FIG. 3 shows a plurality of screws which are distributed over a circumference of a friction disk.

### DETAILED DESCRIPTION

According to the disclosed embodiments, a rail wheel having a wheel brake disk has a wheel body and friction disks fitted thereto on both sides by fastening elements, wherein a multi-layer coating is arranged at least between the respective contact surfaces of the friction disks and the contact surfaces of the wheel body.

The coating has a multi-layer configuration so as to exploit synergy effects of individual material layers, which, for example, increase the temperature resistance or the hardness of the coating overall. The multi-layer coating makes it possible to reduce the extent to which the friction disk is pressed into the wheel body and to reduce a loss of prestressing force of the fastening elements.

In principle, the design and the production of a rail wheel are known, for example, from WO 2009/086900 A1. Here, the adhesive wear is reduced by an intermediate layer made of a metallic sheet, which is arranged between the friction disk or wheel brake disk and the wheel web.

As an alternative to an intermediate layer made of a metallic sheet, the arrangement of a multi-layer coating at least in the respective contact region between the friction disks and the wheel body makes it possible to reduce fretting phenomena and wheel damage. In a manner which saves material, this first material layer can be applied directly to the respective contact surface of the friction disks. As an alternative, the entire friction disk can also be coated.

The multi-layer arrangement of the coating can particularly advantageously already be present on the friction disk before assembly, or can form only upon interaction between the contact surfaces of the friction disk and of the wheel body. It is thus also conceivable, for example, that the contact surface of the friction disk has a first material layer with a high mechanical and thermal load-bearing capacity and the contact surface of the wheel body has a lubricant-containing material layer, which together form a multi-layer coating after the rail wheel has been assembled.

It has been found that phosphate-containing material layers in particular have a high abrasion resistance and at the same time form a very solid composite structure with the metallic substrate of the friction disk, and therefore a detachment of this material layer cannot be observed after a plurality of brake operations, in contrast to in the case of lubricating coatings.

A lubricant-containing material layer can advantageously be applied to the phosphate-containing material layer. In this respect, the phosphate-containing material layer is suitable as a support material and allows for permanent adhesion of the second material layer, for example a curing lubricating varnish or a dry lubricant coating.

According to the disclosed embodiments, a method for producing a rail wheel having one or more friction disks includes:
A) providing a friction disk with a contact surface for applying against a contact surface of a wheel body;
B) phosphating at least the contact surface of the friction disk to form a phosphate-containing material layer;
C) applying a lubricant-containing material layer to the phosphate-containing material layer; and
D) assembling the rail wheel.

The friction disk can usually be provided by casting or forging a shaped part and by subsequent machining.

This is followed by the phosphating, that is the application of a phosphate-containing material layer to the contact surface of the friction disk. As a result, a material layer which has a high mechanical load-bearing capacity and at the same time is thermally stable forms on the contact surface. This acts firstly as a support material for a lubricant-containing layer and prevents the detachment thereof during the braking operation. These synergy effects allow for constant and permanent sliding movements of the contact surfaces of the friction disk and of the wheel body without the occurrence of fretting phenomena.

The use of standardized methods for phosphating the contact surfaces of the friction disks has proved to be expedient in order to achieve the most uniform quality possible for the friction disks and the coatings thereof. In this respect, variant T1 of DIN EN 12476 is suitable.

Here, it is sufficient if the friction disk is coated and is fixed to a metallic, uncoated wheel web of a wheel body. Since the coating of the wheel web involves considerably more work on account of the relatively poor accessibility of the contact surfaces, an additional coating of the contact surfaces of the wheel web would give rise to a further cost factor in the production of the rail wheel. However, it has been found that even the coating of the contact surface of a friction disk ensures a sufficient and permanent reduction of the friction, in order to prevent seizure.

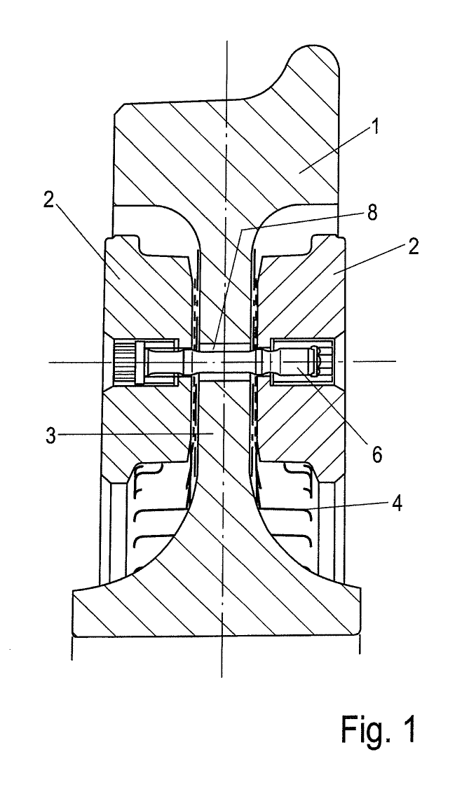

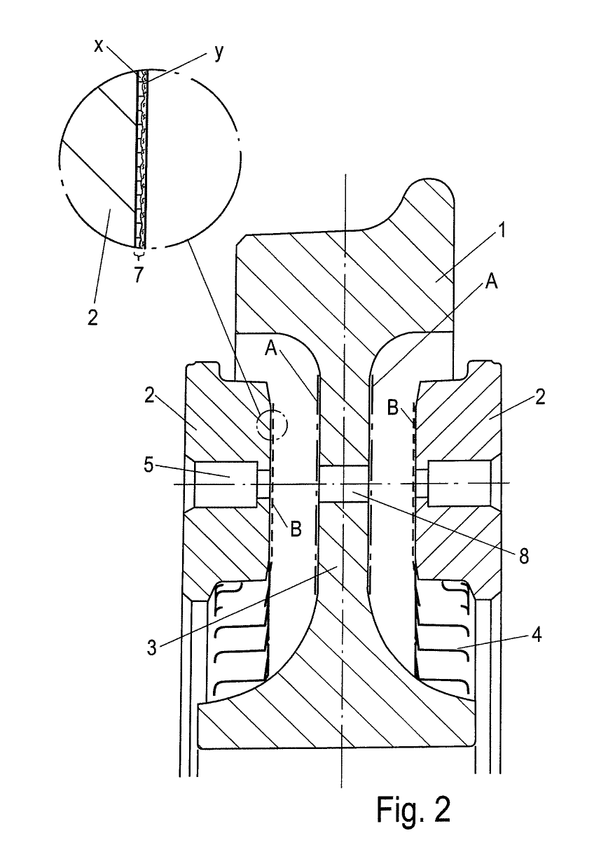

In FIGS. 1 and 2, friction disks 2 are fitted or mounted on a wheel body 1.

Here, a wheel web 3 of the wheel body 1, which forms two circumferential, radially extending contact surfaces A, has a borehole 8, through which a screw 6 which connects the friction disks 2 to the wheel body 1 is guided.

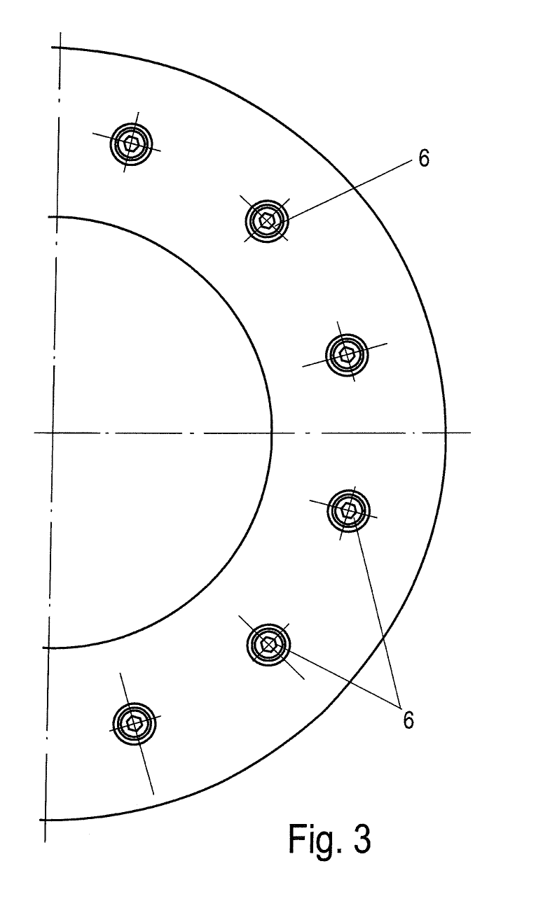

Each screw 6, a plurality of which are distributed at the same angular distance over a circumference, as shown in FIG. 3, is guided through a fastening eye 5 of the respective friction disk 2, which at the end forms an abutment region with respect to the wheel web 3 and also cooling ribs 4 of the friction disk.

A coating 7 assigned to each friction disk 2 is arranged between the abutment regions of the fastening eye 5 and the cooling ribs 4 and the wheel web 3, the contact surface A of the wheel web 3 bearing against the coating on one side and a contact surface B of the friction disk 2 bearing against the coating on the other side.

The coating 7 may be applied to the contact surface B of the friction disk 2. The contact surface A of the wheel web 3 can remain uncoated or optionally can likewise have a coating. This optional coating of the contact surface A can, for example, also be formed in a similar manner to the coating 7 of the contact surface B or as a lubricant layer.

The coating 7 can moreover be distributed over the entire circumference of the friction disk 2 on the contact surface B, or merely in portions to save material. The former option is advantageous for the most uniform possible distribution of heat in the region of the contact surfaces A and B over the entire circumference.

Here, the described coating 7 has at least one phosphate-containing material layer X. The coating of the material layer X may consist of one or more crystalline metal phosphates, optionally of manganese phosphate, zinc phosphate or iron phosphate. The multi-layer coating 7 may have a greater abrasion resistance than the uncoated contact pairing made up of the friction disk 2 and the wheel web 3.

For use on a rail wheel, the layer weight of the phosphate-containing material layer X of the coating 7 of the friction disk 2 may be at least 4 g/m2 to at most 100 g/m2. Coatings with lower layer weights often cannot withstand the mechanical loading, whereas relatively high layer weights have proved to be disadvantageous when making the screwed connections on account of the high value thereof.

The layer thickness of the phosphate-containing material layer X of the coating 7 of the friction disk 2 may be between 5 and 20 μm. If this value of the layer thickness is exceeded considerably, settling phenomena can occur and the screws can become loosened in individual cases.

As the enlarged view in FIG. 2 shows, a further material layer Y is additionally applied to the material layer X of the described coating 7. This material layer consists of a lubricant, optionally a dry lubricant, or at least comprises lubricant particles. The dry lubricants or solid lubricants include inter alia molybdenum disulfide, graphite, PTFE or also alpha-boron nitride. Optionally, the lubricant should in the present case have a temperature resistance of at least 300° C. In this respect, molybdenum disulfide has proved to be particularly suitable for use on a rail wheel.

A coefficient of friction between the contact surfaces A and B at a value which is stable between 0.06 and 0.2 can be made possible by the coating 7. The contact surfaces are redetachable from one another.

A method according to the disclosed embodiments for producing a friction disk 2 for a rail wheel will be described in more detail with reference to FIGS. 1-3.

An uncoated friction disk is provided. This provision can usually include the casting or the forging of a shaped part and if appropriate subsequent machining of the shaped part.

After the machining, the friction disk 2 is provided with a coating 7 at least on the contact surface B, as shown in FIGS. 1 and 2, toward the wheel web 3. This coating has at least one phosphate-containing material layer. Therefore, the application of the coating 7 is referred to as phosphating hereinbelow. The coating may be applied to the contact surface B according to variant T4 of DIN EN 12476.

Alternatively, the friction disk 2 can also be phosphated on all sides, including the contact surfaces B. After the phosphating, the phosphate-containing material layer X may be present in crystalline form on the contact surface B of the friction disk 2, and is an optimum support for further material layers, for example a dry lubricant layer. Even if a brake disk of this type is operated for a relatively long time, there is still always lubricant between the contact surfaces of the friction disk and the wheel web. A good state of contact is thereby achieved permanently.

If required, the phosphating can be followed by the application of a lubricant or a slip agent, which further reduces the coefficients of friction of the friction disk 2 on the wheel web 3 of the wheel body 1.

The thus produced friction disk can be fixed, optionally screwed, to a metallic uncoated wheel web. In this respect, an additional coating process for the contact surfaces A of the wheel web 3, which are relatively difficult to access, can advantageously be dispensed with.

Alternatively, by way of example, a material layer with a lubricant layer can also be applied to the wheel web 3 and, in interaction with the phosphate-containing material layer X, forms a multi-layer coating 7, as soon as the rail wheel is in the assembled state and the contact surfaces A with the lubricant layer and B with the phosphate-containing material layer X bear against one another.

The multi-layer coating also makes it possible to achieve effective corrosion protection for the contact surfaces of the friction disk.

After the friction disk 2 has been coated and assembled, the wheel tub can be flooded with an anticorrosive to preserve the wheel web 3.

### List of Reference Signs

1 Wheel body
2 Friction disk
3 Wheel web
4 Cooling rib
5 Fastening eye
6 Screw
7 Coating
8 Borehole

1. A rail wheel having a wheel body and friction disks fitted thereto on both sides by fastening elements, wherein a multi-layer coating is arranged at least between a respective contact surface of the friction disks and a contact surface of the wheel body.

2. The rail wheel of claim 1, wherein the first material layer is a phosphate-containing material layer which is applied to the contact surface of the friction disk.

3. The rail wheel of claim 1, wherein the temperature resistance of the coating is at least 300° C.

4. The rail wheel of claim 1, wherein the coefficient of the friction of the contact surfaces of the friction disk and of the wheel body is at least 0.06 and at most 0.2.

5. The rail wheel of claim 1, wherein the phosphated material layer of the coating has a layer weight of at least 4 g/m2 to at most 100 g/m2.

6. The rail wheel of claim 1, wherein the phosphated material layer of the coating has a layer thickness of at least 5 μm to at most 20 μm.

7. The rail wheel of claim 1, wherein the phosphate-containing material layer consists of one or more metal phosphates.

8. The rail wheel of claim 1, wherein the coating has a lubricant-containing material layer on a surface of the phosphate-containing material layer which faces toward the contact surface.

9. The rail wheel of claim 8, wherein the lubricant-containing material layer is a curing lubricating varnish.

10. The rail wheel of claim 1, wherein the lubricant-containing material layer comprises at least one dry lubricant or consists of one or more dry lubricants.

11. The rail wheel of claim 10, wherein the dry lubricant is molybdenum disulfide MoS2.

12. The rail wheel of claim 1, wherein the material layer, which lies directly on the contact surface of the friction disk, has a higher mechanical load-bearing capacity and/or a higher thermal load-bearing capacity than the material layer arranged on said material layer.

13. A method for producing a rail wheel having one or more friction disks, comprising:
providing a friction disk with a contact surface for applying against a contact surface of a wheel body;
phosphating at least the contact surface of the friction disk to form a phosphate-containing material layer;
applying a lubricant-containing material layer to the phosphate-containing material layer; and
assembling the rail wheel.

14. The method of claim 13, wherein the phosphating is carried out according to variant T4 of DIN EN 12476.

15. The method of claim 13, wherein the friction disk is fixed to a metallic, uncoated wheel web of a wheel body during assembly.

16. The method of claim 13, wherein a wheel tub of the wheel body is flooded with an anticorrosive after the rail wheel has been assembled.

17. The rail wheel of claim 7, wherein the one or more metal phosphates include manganese phosphate, zinc phosphate and/or iron phosphate.
